(19) United States
(12) Patent Application Publication
(10) Pub. No.: US 2009/0190987 A1
(43) Pub. Date: Jul. 30, 2009

(54) Label Supply and a Label Printer

(75) Inventors: Jos Vleurinck, Oordegem (BE); Dirk Van Britsom, Temse (BE); Elke De Munck, Dendermonde (BE); Tom De Fruytier, Sint Niklaas (BE); Arnaud De Vicq, Antwerpen (BE); Arnout Van Der Hallen, Maasmechelen (BE); Quentin Plaetvoet, Kortrijk (BE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Dymo, Sint-Niklass (BE)

(21) Appl. No.: 12/304,383

(22) PCT Filed: Jun. 11, 2007
(86) PCT No.: PCT/IB07/01665

§ 371 Date: Feb. 18, 2009

(30) Foreign Application Priority Data
Jun. 12, 2006 (GB) 0611581.0

(51) Int. Cl. B41J 11/44

(52) U.S. Cl. 400/76

(57) ABSTRACT

A supply for a label printer comprising of an image receiving medium for receiving an image and tags for receiving digital information.

The present invention relates to a supply for a label printer, to a label printer and to a method for creating labels, more specifically but not exclusively to a method for creating RFID labels.

Label printers are known. Known tape printing apparatus of the type with which the present invention is concerned are disclosed in EP-A-322918 and EP-A-322919 (Brother Kogyo Kabushiki Kaisha) and EP-A-267890 (Varitronic). The printers each include a printing device having a cassette receiving bay for receiving a cassette or tape holding case. In EP-A-267890, the tape holding case houses an ink ribbon and a substrate tape, the latter comprising an upper image receiving layer secured to a backing layer by an adhesive. In EP-A-322918 and EP-A-322919, the tape holding case houses an ink ribbon, a transparent image receiving tape and a double sided adhesive tape which is secured at one of its adhesive coated sides to the image tape after printing and which has a backing layer peelable from its other adhesive coated side. With both these apparatus, the image transfer medium (ink ribbon) and the image receiving tape (substrate) are in the same cassette.

It has also been proposed by the present applicants in, for example, EP-A-578372 to house the ink ribbon and the substrate tape in separate cassettes.

In all of these cases, the image receiving tape passes in overlap with the ink ribbon to a print zone consisting of a fixed print head and a platen (or vice versa) against which the print head can be pressed to cause an image to transfer from the ink ribbon to the image receiving tape. There are many ways of doing this, including dry lettering or dry film impression, but the most usual way currently is by thermal printing where the print head is heated and the heat causes ink from the ink ribbon to be transferred to the image receiving tape.

It is also know to print images on tape without using an ink ribbon. In this case the image receiving tape is thermally sensitive and the image is printed thereon by the thermal print head.

The image receiving tape may be in the form of a continuous tape. An image is printed and the tape is then cut by the label printer to the appropriate length. It is also known that the image receiving tape may comprise a backing layer on which there is a plurality of discrete or die cut labels.

The printers may be hand held or desktop, stand alone printers. Alternatively the printers may be arranged to be connected to a personal computer PC or the like.

RFID labels are known which comprise a label in which a RFID tag is provided. Label printers can print on RFID labels. A roll of die cut labels with integrated RFID tags is provided in a label printer and the printer prints an image on the roll of die cut labels. This known system has the disadvantage that the dimensions of the RFID labels are predefined. Users who want to print a small label and subsequently a larger label would have to change label supplies which is inconvenient.

In for example an office environment, a number of so called “assets” are available and are shared by a number of users. For example, there may be pool laptops, computers, scanners, projectors. It can be difficult to keep track of these devices and, in particular, who has those devices at any given time.

RFID labels are for example used in equipment management systems. There are equipment management systems which use RFID labels to identify equipment in a given area. The disadvantage of the known systems with RFID identification is the difficulty in locating the equipment. To have sufficient preciseness, a large number of readers need to be installed throughout the area which is expensive.

Other equipment management systems are web based and count on the goodwill of the user to access the software and to enter or change the necessary information. This does not always happen.

It is an aim of the embodiments of the present invention to address one or more of the described problems.

Various aspects of the invention can be seen from the appended claims.

For a better understanding of the present invention and as to how the same may be carried into effect reference will now be made by way of example to the accompanying drawings in which:

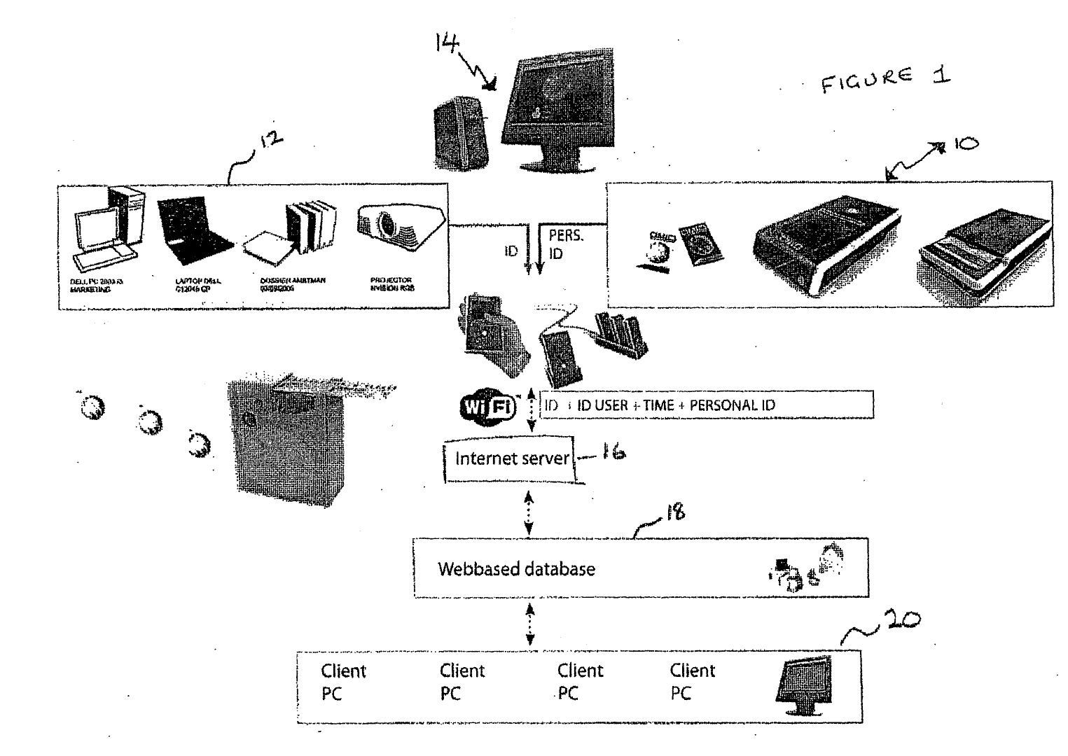

FIG. 1 shows schematically a system embodying the present invention;

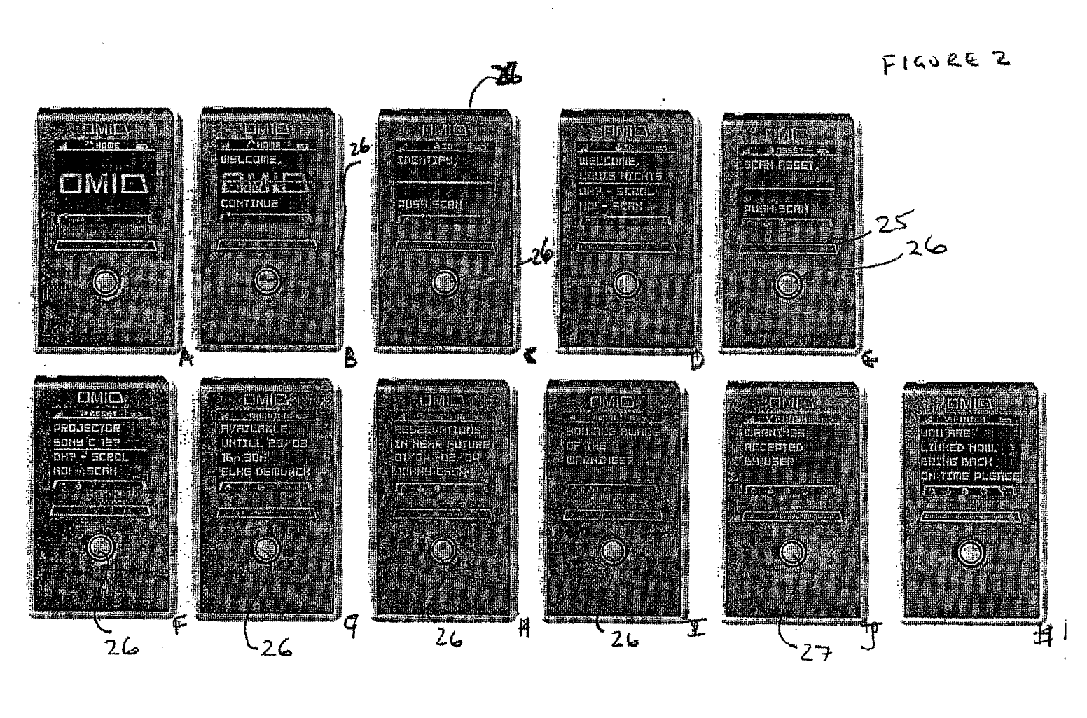

FIG. 2 shows a front view of the device embodying the present invention of FIG. 1 for reading labels in more detail and in particular FIGS. 2a to 2k show a series of messages displayed to the user;

FIG. 3 shows the rear of the device of FIG. 2;

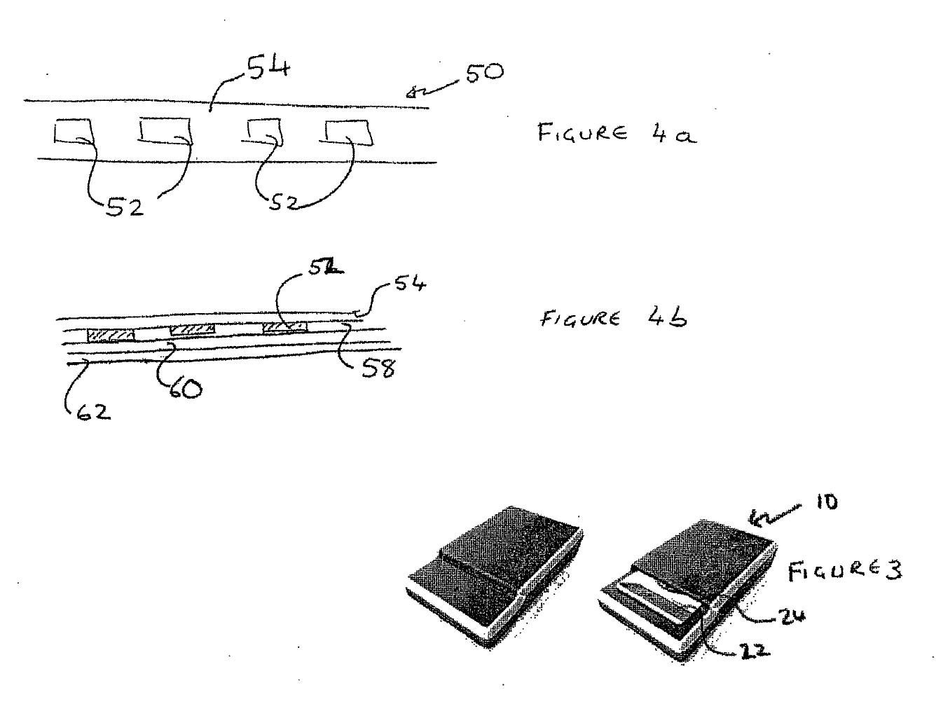

FIG. 4a shows a view of a first label material embodying the invention;

FIG. 4b shows a cross section of the label material of FIG. 4a;

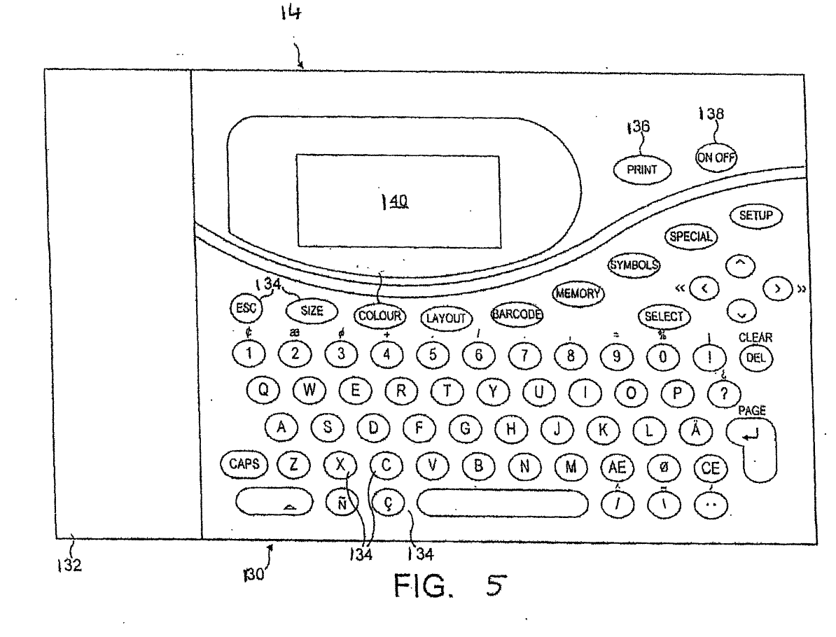

FIG. 5 shows one label printer embodying the invention;

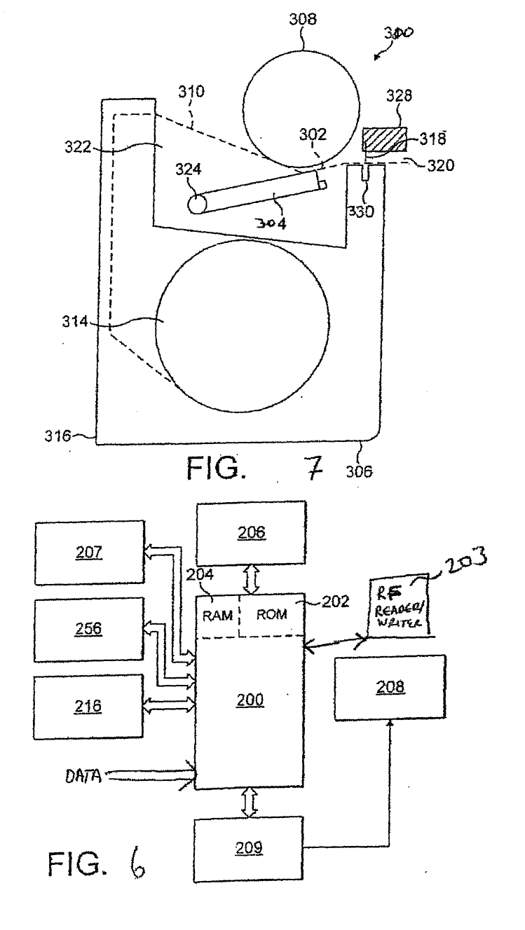

FIG. 6 shows schematically elements of a label printer embodying the present invention;

FIG. 7 shows a cassette used in embodiments of the invention with elements of the label printer;

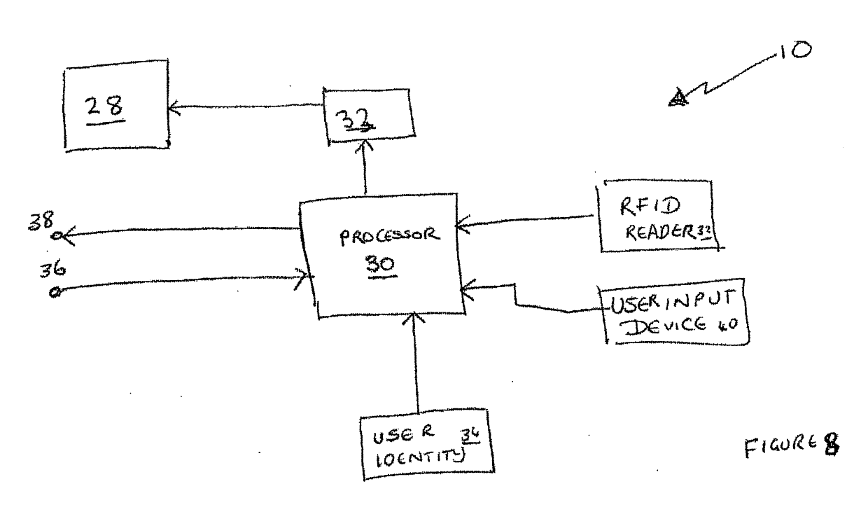

FIG. 8 shows schematically elements of the device of FIG. 2;

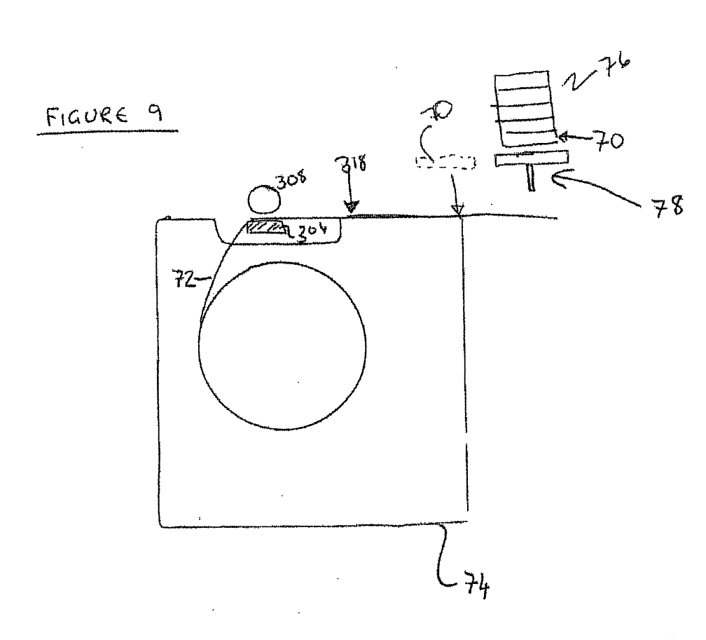

FIG. 9 shows a second cassette arrangement with elements of the label printer, in accordance with a further embodiment of the invention;

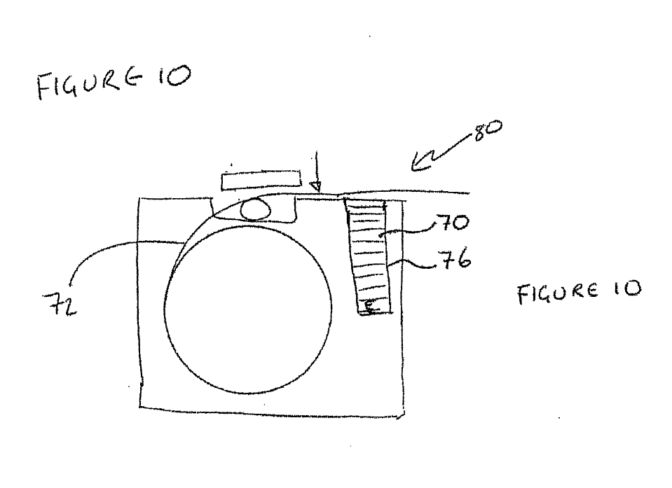

FIG. 10 shows a third cassette arrangement with elements of the label printer, in accordance with a further embodiment of the invention;

FIG. 11 shows a supply of RFID tags used in a further embodiment of the invention;

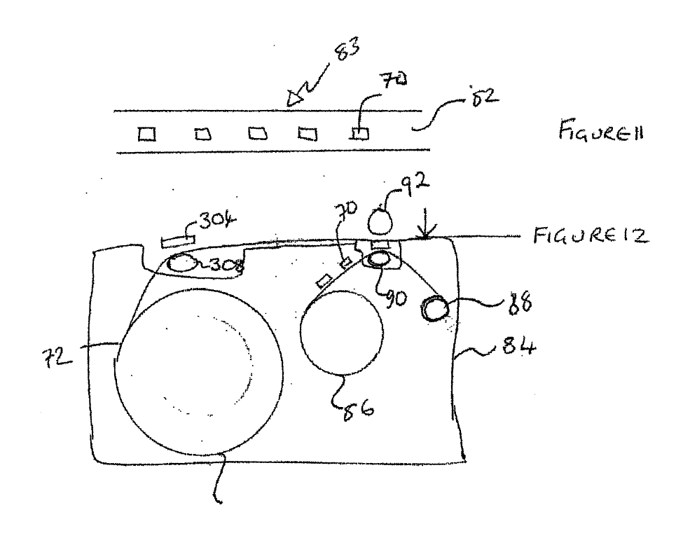

FIG. 12 shows a fourth cassette arrangement with elements of the label printer, in accordance with a further embodiment of the invention;

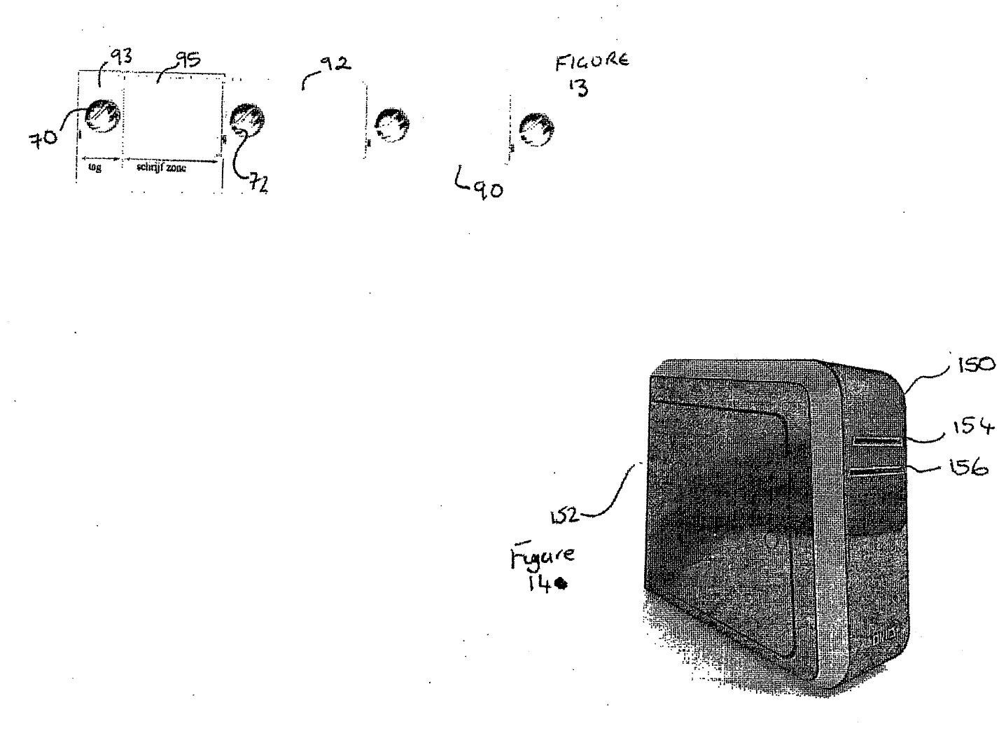

FIG. 13 shows a further label supply, embodying the present invention; and

FIG. 14 shows a further label printer embodying the present invention.

Reference is made to FIG. 1 which schematically shows a first embodiment of the present invention.

Readers 10 are provided. The readers 10 are arranged to obtain personal identity information from an individual who is using a piece of pool equipment. This will be described in more detail hereinafter.

Reference numeral 12 shows schematically so called “pool” items which may be used by a number of different individuals. By way of example only, these items can include computers, portable computers, laptops, projectors, screens and mobile phones. It should be appreciated that the pool items can of course be other items such as books, documents or even much larger items such as furniture. Each of these items has associated with an identity. This identity is contained on a tag. As will be discussed later, this tag can take any suitable format but in preferred embodiments of the present invention is an RFID tag. In preferred embodiments of the present invention, the RFID tag contains information identifying the device. Additionally the RFID tag may be provided with a label containing visual information. This visual information may contain the same identity information as the tag. Alternatively, the label containing the visual image may contain additional information or alternative information to that contained in the RFID tag.

As will be described in more detail hereinafter, the RFID tags and visual labels may be provided by device 14. Device 14 comprises a PC to which is connected to a label printer. The label printer is able to print an image onto a label, write digital data to a RFID tag and to provide a single label comprising the RFID tag and the visual image.

When a user wants to borrow a piece of equipment, the user registers his personal identity with the reader 10. This personal identity is sent to an internet server 16 The server does not need to be an internet server, it can be just a network server or any other suitable server or even a PC or the like. The personal identity is sent along with the time and potentially, but not necessarily, the identity of the equipment. The identity of the equipment is obtained from the RFID tag by the device 10 which has an RFID reader.

The obtained information is sent, along with the identity of the device 10, via a wireless link to the internet server 16 which is connected to a web based database 18. The link does not need to be wireless. In another embodiment, the reader can look like a USB stick and connection can be made by plugging the reader device in the PC. The database need not be a web based database and can be any other suitable database.

This web based database 18 can be accessed by a plurality of client computers 20 or PCs. The web based database 18 will thus include a record as to when an identified user checked out a piece of equipment. The client personal computers 20 as well as all other readers in the network are able to access the database in order to ascertain who has a particular piece of equipment.

It should be appreciated that in preferred embodiments of the present invention, the reader 10 is able to obtain personal identity information from the user and also to read the RFID tags provided on the equipment 12. However, in alternative embodiments of the invention, these functions may be provided by separate devices.

The device 10 will now be described in more detail with reference to FIGS. 2, 3 and 8. The reader shown in FIG. 2 is able to obtain the personal identity of a user. There are a number of different ways in which this can be achieved. In embodiments of the present invention, the reader is able to obtain this information from the user in one or more different ways.

In a first arrangement, the user has an identity card. Employees of companies are often given identity cards which contain information to allow them, for example access to certain areas. The information is provided on the card in a number of different ways. For example, the card may contain a magnetic strip with information, contain an integrated circuit or chip or contain information in any other suitable way. The reader 10 has a slot 24 into which the card can be inserted. It is of course possible for the reader of the device 10 to read the information contained on the user's card in any other suitable way, by a contact mechanism, a swipe mechanism or the like. The reader reading the identity of the user can happen without any user interaction in case the identification is done by a card that has been inserted in the device.

The reader may alternatively have an input which allows the user to input his or her name and/or a PIN (personal identification number) code or any other identification information. The input can for example be provided by a key pad, a touch screen or the like. The reader may contain a list of names through which the user is able to scroll until his or her name is reached and then the users name is selected.

It is possible for biometric information to be obtained from the user. For example, the reader may comprise a fingerprint recognition device which is able to recognise the fingerprint of authorised users.

It should be appreciated that the reader 10 may comprise sufficient intelligence in order to identify the user. In alternative embodiments of the present invention, the reader may alternatively send data obtained from the user to a server or the like. The server or the like will process the data received from the reader 10 in order to identify the user.

FIG. 2 shows how the device 10 can be used as an interface to the system, showing the various different messages which are shown to the user. In FIG. 2a, the home screen is shown. In FIG. 2b, a personalised welcome screen is shown after reading the user's identity. This may be obtained by activating button 26. This is optional.

In FIG. 2c, the user is invited to identify himself. In the embodiments shown in FIG. 2, a finger print detection method is used. In this embodiment, the user would place his finger on the screen 28 of the device. This screen 28 contains a fingerprint detection device. To commence the finger printscan, button 26 is activated. Alternatively the scan could start by itself on a time-base.

The device illustrated in FIG. 2 has intelligence and as such is able to identify the user. In FIG. 2d, a message is displayed which indicates the identity of the user and asks the user to confirm via button 26 that the correct identity has been obtained. The device shown also has a slider 25. This may be a capacitive slider, without any moving parts. By moving the slider 25, the user is able to scroll through different options which are displayed. The slider can also be oriented in a vertical way. The activation of button 26 will allow the highlighted option to be selected.

The button may be a simple button which has a simple on click function. Alternatively, the button may be more sophisticated like a joystick type of button as seen on mobile phones and also allow the user to scan through different options. In this latter case, the slider may be omitted.

Of course alternative embodiments of the invention may use any other suitable method for controlling the displaying and selection of options.

In FIG. 2e, the screen is shown where the user has confirmed by activating button 26 that the user has been correctly identified. The user is invited to scan the equipment which the user would like to borrow. In the preferred embodiment of the present invention, the device 10 has an RFID reader. The user is invited to scan the RFID tag of the equipment to be borrowed. The scanning operation is commenced by activating button 26.

In FIG. 2f, the scanning operation has been completed and the item scanned is indicated on the screen. The user is invited to confirm, in a similar way as described in relation to FIG. 2d that the identified equipment has been correctly identified. Again, this is done using the button 26.

In FIG. 2g, the user has confirmed that the equipment has been identified correctly and further information is provided to the user. In particular, the information obtained by the reader indicates the length of time for which the product is available. This information will be obtained from the web based database 18. This will require there to be a link 10 between the reader and the database 18. This link may be via a wired or wireless connection. The connection may be a direct connection or an indirect connection. In case of a non-direct connection, the reader device may contain a or a part replica of the database in its memory. Thus, the user knows how long he is able to use the equipment 4. To indicate that the user has understood, the button 26 is activated.

In one embodiment of the invention, the database is stored on the device 10.

FIG. 2h shows further information which is available about the equipment from the database. For example, the other people who have reserved the equipment are shown as well as when they have reserved the equipment. Again, to show that the user has understood, the button 26 is activated.

There may be access rights defined in the system that allow some users to see more information than others.

FIG. 2i shows a message which requires the user to confirm that they understood effectively the length of time for which they are able to use the equipment. This acceptance is carried out by again activating button 26.

FIG. 2j shows a message which confirms to the user that the limitations on the usage have been accepted. Again, to move onto the next screen, the button 26 is activated.

The final message displayed to the user in FIG. 2k indicates that the user has now been associated with the borrowed equipment in the data base. The user is then invited to bring back the equipment on time.

It should be appreciated that the messages shown in FIG. 2 are by way of example. The exact format of the messages may of course be varied. It is also possible in some embodiments of the present invention to omit one or more of the steps shown.

In the reader shown in FIG. 2, the user is able to obtain information about the identity of the user, read the RFID information from the equipment to be borrowed and also to obtain information from the data base as to any related information relating to the equipment to be borrowed, such as information as to how long the product is available, when it is due for maintenance, etc.

It is possible for these functions to be carried out by separate devices. In that case, the information gathered would be fed to a single device which is able to carry out the functions of the reader discussed in relation to FIG. 2.

Reference is made to FIG. 8 which shows schematically the structure of the reader device 10. The device has a display 28. A central processor 30 is provided. The processor 30 is connected to a display driver 33. This driver may be embedded in the processor device. The display driver 33 is in turn connected to the display 28. The processor 30 controls the messages which are displayed on the display 28.

The processor is connected to an RFID reader 32. This RFID reader is able to read the RFID tags on the equipment. The processor is also connected to a user identity obtaining device 34. This user identity obtaining device 34 can comprise a finger print detector, a keyboard through which the user is able to input data, be part of the screen 28 where the screen is a touch screen, or be a card or similar device reader. It is possible that the user identity device is the same as the identity obtaining device and thus only one of the two is provided. For example, the user identity information may be obtained from an RFID tag of the user. The device also contains an external output/input 36 potentially through a connectivity component which is arranged to receive information from the web based database 18. The input/output may be provided by a port for a wire of by a wireless antenna or the like.

Also provided is the user input device 40. The user input device provides input information which is input to the processor 30. This user input device may be the button 26 shown in FIG. 2, a keyboard, a touch screen, a wheel or the like. This may in some embodiments be the same as the user identity device 34.

Also provided is an output 38. This allows the processor 30 to output requests to the database for information associated with the identified user and/or the identified equipment. The output 38 also allows reservations of the particular equipment by a particular individual to be sent to the database 18 which can be thereby updated. This may be part or the input or be separately provided.

Thus, the processor 30 controls the screen and the output 38 of the device based on information received via its input 36, information from the user identity unit 34. Information received from the user input device 40 and/or information received from the RF reader 32.

As explained above, one or more of the devices providing an input to the processor may be separately provided. In such an embodiment, the processor 30 may thus form part of a PC or the like.

Reference is now made to FIG. 4a which shows a supply of label material 50. The supply of label material 50 comprises an image receiving layer 54 and a plurality of RFID tags 52.

Reference is made to FIG. 4b which shows a schematic cross section through the label material of FIG. 4a.

A first layer 54 is provided. This is the layer on which an image is printed.

Adhered to the underside of this layer 54 is the plurality of RFID tags 52. In other words, the RFID tags are provided on an opposite surface of the image receiving material 54 to that side on which the image is printed. The RFID tags 54 are stuck to the rear side of the image receiving layer 54 by an adhesive. In some embodiments of the present invention, a filler material 58 may be provided around the IC's of the RFID tags. This filler material has the function so that the surface on which the image receiving tape is planar and does not have bumps resulting from the presence of the RFID tags. The filler material 58 may also have an adhesive function.

A backing layer 60 is provided. The backing layer 60 and the layer 54 to which the image is applied provide a sandwich construction with the RFID tags 52 arranged therebetween. A suitable adhesive is provided in order to adhere the layer 60 to the RFID tags and the optional filler material 58. In some embodiments of the present invention, the side of the layer 60 opposite to that with the RFID tags is provided with an adhesive. A peel layer 62 is provided on the adhesive layer. In this way, when layer 62 is removed, the layer 60 can be adhered to a surface.

It should be appreciated that in some embodiments, there may be more or less layers than that shown in FIG. 4b. For example, layer 60 can be omitted. A further layer may be provided on top of the layer 54 on which the image is printed. This may be a so called lamination layer which protects the printed image. This may be applied after an image is printed or may be provided when the label material is made. In case of lamination, the imaging may be done on the lower side of the transparent protective layer rather than on layer 54.

Reference is made to FIG. 7 which shows in plan view the label printing device 14 embodying the present invention which has a cassette 306 arranged therein. This cassette can contain a supply of material as discussed above. The cassette 306 is located in a cassette bay 316. The cassette bay 316 also accommodates at least one thermal print head 304 and a platen 308 which cooperate to define a print zone 302.

The print head 304 is able to pivot about a pivot point 324 so that it can be brought into contact with the platen 308 for printing and moved away from the platen 308 to enable the cassette 306 to be removed and replaced. In the operative position, the platen 308 is rotated to cause the image receiving tape 310 to be driven past the print head 304.

The platen 308 is driven by a DC motor (see FIG. 6) so that it rotates to drive the image receiving tape through the print zone 302 of the tape printing device 301 during printing. In this way, an image is printed on the tape and fed out from the print zone 302.

The image is printed by the print head 304 on the image receiving tape on a column by column basis with the columns being adjacent one another in the direction of movement of the tape 310. Pixels are selectively activated in each column to construct an image in a manner well known in the art. The DC motor is provided with a shaft encoder for monitoring the speed of rotation of the motor. The control of the speed of the motor is achieved by the microprocessor chip 100 (see FIG. 6) to generate data strobe signals each of which causes a column of pixel data to be printed by the print head 304.

The tape printing device may include at cutting location 320 a cutting mechanism 328 which carries a blade 318. The blade 318 cuts the image receiving tape 310 then enters a slot 330 located in the cassette 306.

The image receiving material on which the image is printed may be thermally sensitive. In this arrangement, the image is printed as a result of the contact between the image receiving material and the heated elements of the print head. There is no ribbon.

In alternative embodiments of the present invention, the image receiving layer may require the presence of an ink ribbon. In those embodiments, the ink ribbon may be incorporated in the same cassette. In such an arrangement, the cassette would have an image ribbon supply reel and a take-up spool. This ink ribbon would be positioned so as to be driven in overlap with the image receiving material between the print head and the platen. The ink ribbon would be in contact with the print head. The application of heat to the ink ribbon records the image to be applied to the image receiving medium.

In alternative embodiments of the present invention, the ink ribbon can be housed in a separate cassette.

Embodiment of the present invention can be used with any other suitable printing technology such as inkjet printing, laser printing or any other printing technique.

It should be appreciated that in some embodiments of the present invention, the supply of image receiving tape is not included in a cassette but is simply provided on a spool or reel.

In an alternative embodiment of the present invention, the RFID tags are arranged to be applied to the tape after the image receiving material after the image has been printed thereon. This method has the advantages that there is a smooth surface without bumps on which the image can be printed. Secondly, the label can have any desired length and thirdly only one single RFID tag is provided per label which is economic.

The arrangement shown in FIGS. 4a and b is advantageous in that a single tape needs to be handled so that the label printer is simplified. However, the label printer would need to be controlled to make sure that cuts are only provided between RFID tags or at the very least do not cut through the tag on which the information is included. This for example could be implemented by markings on the reverse of the image receiving tape which correspond to the position of the RFID tags. The printer would then be controlled to feed the tape such that the cutter is located in a region which is between the RFID tags.

Reference is made to FIG. 9 which shows a first arrangement where the RFID tags 70 are separate from the image receiving material 72. The image receiving material 72 is housed in a cassette 74. The supply of image receiving material is fed out of the cassette. When in the printer, an image would be printed on the image receiving tape by the printer, print head 304 acting against the platen 308. The image receiving tape would then be cut by cutter 318.

FIG. 9 shows schematically a supply 76 of an RFID tags. These tags are arranged in a stack or a pile. A mechanism 78 is used to take an RFID tag 70 and apply that tag 70 to the side of the image receiving material 72, opposite to the side on which has been printed.

In one embodiment of the present invention, the underside of the image receiving material has an adhesive applied thereto. This adhesive is used in order to cause the RFID tag 70 to adhere thereto. In such an embodiment, the underside of the image receiving tape may have a backing layer. This backing layer maybe peeled away locally from the underside of the image receiving tape before the RFID tag is applied thereto. The cutter 318 may be arranged to cut through the material completely and also to cut partially through the backing layer. The cutter may comprise one or two blades for this purpose.

In one embodiment, the tape can be delaminated (that is have a liner layer removed), then tags can be applied to a sticky side of the label, then tape is re-laminated with the same or a different liner.

FIG. 10 shows a modification to the supply of FIG. 9. In the arrangement shown in FIG. 10, the supply 76 of RFID tags is provided in the cassette along with the supply of image receiving material. In this cassette 80, there is the supply of image receiving material 72. The RFID tags 70 are again arranged in a stack, for example guided by the sides of a tube. The cassette would have a simple mechanism which could be activated by the label printer which would permit a RFID tag to be dispensed and adhered to the side of the image receiving tape opposite that on which the image is printed.

The printer can have two modes, one makes labels with an RFID tag included, the other does not include the tags in the label. This can be controlled via the user input or may be automatically determined based on the detection of RFID tag supply.

Again, as with the previous embodiment, one or both of the image receiving tape and RFID tag is provided with an adhesive so that the image receiving tape and RFID tag adhere to one another.

Reference is now made to FIG. 11 which shows an alternative for the supply of RFID tags. In particular, the RFID tags 70 are provided on a backing layer 82. An adhesive is provided between the RFID tags 70 and the backing layer 82 such that the RFID tags 70 are retained in place on the backing layer but at the same time can be peeled therefrom.

Reference is made to FIG. 12 which shows a cassette 84 incorporating the RFID supply as shown in FIG. 11. A supply of image receiving tape 72 is provided. The image receiving material 72 passes between a print head 304 which prints an image as the print head presses against the platen 308.

The cassette also has a supply 86 of the material 83, that is the backing layer 82 with the supply of RFID tags 70 thereon. A driven take-up spool 88 is provided for the backing material 82, once the RFID tag has been removed.

A roller 90 is provided in the cassette which acts against a roller 92 of the tape printer. The image receiving tape 72 on which the image has been printed passes between the two rollers 90 and 92. Additionally, the take-up spool 88 can be driven when required so that a RFID tag passes between the roller 90 and 92. This causes the RFID tag 70 to be applied to the reverse side of the image receiving medium 72.

The image receiving tape with the RFID tag can be cut downstream of the two rollers 90 and 92. The cutting mechanism is provided in the label printer.

In preferred embodiments of the present invention, at least one of the rollers 90 is moveable towards the other. Accordingly, when the image is being printed the two rollers may be separated from one another. However, when an RFID tag is to be applied, at least one of the rollers is moved towards the other and the take-up spool 88 is activated in order to cause it to drive an RFID tag between the rollers 90 and 92.

It should be appreciated that both of the rollers 90 and 92 may be provided in the label printer. One of the rollers may be replaced by a flat surface such as a wall or the like.

The take-up spool 88 may be provided in the label printer rather than in the cassette.

It should be appreciated that in some embodiments of the present invention, the supply of RFID tags may be provided in a separate cassette.

In yet another alternative embodiment of the present invention, the image receiving material 72 and the supply 83 of RFID tags maybe provided on spools and not contained in a single cassette.

In yet another modification, the image receiving tape is received in a cassette where as the supply of RFID tags are held on a spool or reel.

The RFID inlays may be contained in and supplied from a separate cassette. So, a 3-cassette system could be included. This allows even more flexibility for the end user. Reference is made to EP03795979.8 in the name of the present applicant which describes a method of carrying out compatibility checks which can be used to check if the three parts (tape, ribbon, RFID inlays) actually can fit together to create a label.

In the embodiments shown in FIGS. 9, 10 and 11, the position of the platen and print head is shown schematically to assist in the understanding of embodiments of the present invention. However, it should be appreciated that the position of the print head relative to the image receiving tape will be dependent on the side of the image receiving tape on which an image is to be printed. Thus, in preferred embodiments of the present invention, the RFID tags are applied to the side of the image receiving tape opposite to that on which the image has been printed.

It should be appreciated that in some embodiments of the present invention, the cassettes shown in FIGS. 9, 10 and 12 may additionally incorporate an ink ribbon. An alternative embodiment of the present invention, a separate cassette containing the ink ribbon may be provided. In yet another alternative embodiment of the present invention, the ink ribbon and the RFID tag may be provided in one tape cartridge.

Reference is made to FIG. 13 which shows a further embodiment of the present invention. In this embodiment, a backing layer 90 is provided. Attached to this backing layer 90 is a plurality of discrete labels 92. These labels are so called “die cut” labels. Each label is provided with an RFID tag 70 on the label. The label 92 therefore 92 has two zones. In the first zone 93, the RFID tag is accommodated. This may be the leader part of the label. In the second zone 95, an image can be printed. In one modification to this embodiment, the RFID tag is provided on the opposite side of the label and accordingly, the zone on which the image can be printed extends over the entire length of the die cut label 92.

The supply of die cut labels shown in FIG. 13 may be accommodated in a cassette, or in alternative embodiments may be provided on a supply spool.

In embodiments of the present invention, the RFID tag may be a tag to which it is possible to write only once. In alternative embodiments of the present invention, it may be possible to write to the same RFID tag many times.

In some embodiments of the present invention it might be possible to have read only tags. However, preferred embodiments of the present invention allow the RFID tags to be written to. However this is not necessary. In case the RFID tags are read-only, they always have a unique identifier in them, for technical reasons put in by the manufacturer of the tags. This number is sufficient for the system to be used in the asset database.

RFID tags which are used in preferred embodiments of the present invention can take any suitable format. An example of a RFID tag that can be used with embodiments of the present invention are the “Texas Instruments tag-it™ HF-I Standard Transponder Inlays”.

Embodiments of the present invention have been described in the context of using RFID tags. However, it should be appreciated that embodiments of the present invention are not limited thereto. The tags may use different technology such as being an EPROM, a chip, or the like. The frequency used in order to read/write to the tag can be a radio frequency, ultra-violet, infrared or any other suitable frequency. The tags may be read visually e.g. 2D barcodes. But preferably the reading is done without line of sight, so that assets may be in a box or bag and don't need to be unpacked before being scanned.

Reference will now be made to FIG. 14 which shows schematically a label printer embodying the present invention.

It is often desired to label a number of articles with consecutive numbers. Accordingly, in embodiments of the present invention, it is possible to select a range of consecutive numbers and to automatically print out labels with individual labels containing one of the respective consecutive numbers. The RFID tag would be automatically programmed to include the corresponding number. Such a system can be used for marking files, documents and the like.

Embodiments of the present invention may be arranged to write information to the RF tag. For example, in one embodiment of the present invention, the RF tag may be programmed to have an expiry date. When a particular piece of equipment is used for example, in an office, there may be RFID detectors positioned at various locations. Accordingly, when the user has had the item longer than the expiry date, an audible warning may be set off, or a message may be sent to the user.

In one embodiment of the present invention, the web based data base has information indicating the date by which the piece of equipment needs to be returned. If that time is exceeded, then the server may be arranged to automatically generate a message which is sent to the user. This may be in the form of an email, a text message or by any other suitable means. The email option is preferred in that the internet server can generate the message and distribute it correctly to the user.

In one modification, the user is given a warning that he has to return the equipment by a given time. If the equipment is available after the expiry time, the user may be given the option of an extending the time for which he can use the equipment.

In yet another alternative embodiment of the present invention, the web based data base can be used in order to generate a message which is sent to the user who has booked the next slot for a particular piece of equipment. This message can for example indicate who currently has the equipment.

As mentioned, embodiments of the present invention can be used for items other than equipment. For example, embodiments of the present invention can be used to manage books in a document centre or library. Alternative embodiments of the present invention can be used to manage files.

Embodiments of the present invention have been described in the context of a system where pool or common equipment is available to a number of different users. Embodiments of the present invention can be used to label items in order to distinguish therebetween. For example, a number of users in an organisation may be provided with the same equipment. The labels can be used to mark the equipment with some identification information to associate that equipment with a particular user.

The presence of the RFID tag may allow the user to quickly find their piece of equipment by making use of their reader device.

Another application of embodiments of the present invention is labelling equipment in a network. The equipment can be labelled with a label embodying the present invention. This allows a manager or user of a network to identify a particular piece of equipment and use the RFID tags to physically locate that piece of equipment, that is know where it is located. Often, with a network, it is possible to print to a number of different printers. Often a particular printer will have a function which is not offered by very many other printers. Accordingly, a user may select this particular printer in order to utilise that function. The embodiment described allows the location of that item to be quickly determined so that the user can physically locate the printer which has printed out his document. Additionally, articles can be moved around within the network and again their physical location can be readily identified by a user.

Embodiments of the present invention have been described in the context of a web based data base. The data base can of course be provided in any suitable format and can be arranged to be accessed by a number of different people on a network. An alternative embodiment of the present invention, the data base may be held in a single location to which only perhaps a single person has access.

In embodiments of the present invention, a particular environment may have a number of RFID detectors, for example a range in particular rooms, on doors etc. Items moving past these detectors may be registered and the movement of the device within the environment may be recorded on the data base.

Reference is now made to FIG. 14 which show the label printer embodying the present invention in more detail. The preferred embodiment of the present invention is a label printer 150 which is arranged to be connected to a PC or the like. As such, the printer does not require a display or keyboard, those of the PC being used. The label printer 150 shown in FIG. 14 comprises a cassette receiving bay 152 in which the supply of image receiving tape and the supply of RFID tags is received. As discussed previously, the supply of image receiving material and RFID tags can be provided in a common cassette, in separate cassettes, on supply reels or combinations thereof.

The printer 150 shown in FIG. 14 has a slot 154 through which the label including the RFID tag is fed, after the image has been printed on the tape and the RFID tag has the required digital information written thereto.

The printer 150 has a memory card slot 156 in which a memory card, memory stick, or smart card can be inserted.

This memory card may contain the data written to the card by the device 10.

Thus, the printer 150 may get the data to be written to the RFID tag and printed on the label from the smart card or the like.

Alternatively, the PC to which the label printer 150 is connected may be connected to the web based data base. This allows the desired information to be printed on the label.

In another embodiment, the printer can include the web server. Such a printer is network enabled, for example, has an Ethernet connection. The database resides in the memory of the printer and can be accessed through TCP/IP Ethernet protocol from any computer supporting this protocol.

Alternatively, a connection can be made between device 10 and the label printer 150 and information is sent from device 10 to the label printer.

FIG. 5 shows a schematic diagram of an embodiment of an alternative label printing apparatus 14 according to the present invention. The label printing apparatus comprises a keyboard 130 and a cassette receiving bay 132. The keyboard has a plurality of data entry keys 134 such as numbered, lettered and punctuation keys for inputting data to be printed as a label and function keys for editing the input data. The keyboard may also have a print key 136 which is operated when it is desired that a label be printed. Additionally an on/off key 138 is also provided for switching the tape printing apparatus on and off.

The tape printing apparatus has a liquid crystal display (LCD) 140 which displays the data as it is entered. The display allows the user to view all or part of the label to be printed which facilitates the editing of the label prior to its printing. Additionally, the display is driven by a display driver (not shown).

Basic circuitry for controlling the label printing device 1 is shown in FIG. 6. There is a microprocessor chip 200 having a read only memory (ROM) 202, a microprocessor 201 and random access memory capacity indicated diagrammatically by RAM 204. The microprocessor chip 200 is connected to receive label data input to it from a data input device such as a keyboard 206. The microprocessor chip 200 outputs data to drive a display 208 via a display driver chip 209 to display a label to be printed (or a part thereof) and/or a message for the user. The display driver alternatively may form part of the microprocessor chip. Additionally, the microprocessor chip 200 also outputs data to drive the print head 216 so that the label data is printed onto the image receiving tape to form a label. Finally, the microprocessor chip 200 also controls the motor 207 for driving the platen. The microprocessor chip 200 may also control the cutting mechanism to allow a length of tape to be cut off. In alternative embodiments at least part of the cutting mechanism may be manually operated.

The circuitry also includes a RFID reader/writer 203 which is able to write to and/or read data from a RFID tag.

If the tape printer of the present invention is a PC printer rather than a stand-alone printer, the keyboard and display means are not essential as the data may be input and displayed on the PC. The PC then acts as an input device for the printer. Alternatively, other apparatus may be used to input data to the printer for printing. For example, in an embodiment of the invention a digital camera or a mobile phone may be used to input data to the tape printing device for printing. Images may alternatively be input using a smart card, chip card, memory card or the like.

In some embodiments of the present invention, the tape printer may be connected to a PC. In those embodiments, the tape printer may not have a keyboard or display. However, in some embodiments the tape printer will additionally have the display and keyboard.

1-38. (canceled)

39. A label printer comprising:
a print head for printing an image on an image receiving medium;
wherein a tag is adhered to a backing layer that extends between a supply and a take-up spool; and
wherein the printer includes a driver configured to drive the take-up spool to cause the backing layer to be driven between the supply and the take-up spool.

40. A printer as claimed in claim 39, wherein the backing layer extends over a roller or wall between the supply and the take-up spool, and the driver comprises a driver configured to drive the take-up spool to cause the backing layer to be driven over the roller or wall.

41. A printer as claimed in claim 40, wherein the driving of the backing layer over the roller or wall causes the tag to peel from the backing layer and to be applied to the image receiving medium.

42. A printer as claimed in claim 40, wherein said roller or wall is part of a cassette.

43. A printer as claimed in claim 39, including the take-up spool.

44. A printer as claimed in claim 39, including a receiving bay for receiving the image receiving medium in a first cassette or on a first spool, and a receiving bay for receiving the supply in a second cassette or on a second spool.

45. A printer as claimed in claim 40 further comprising a second roller, wherein the backing layer is arranged to pass between the second roller and said roller or wall.

46. A printer as claimed in claim 40, wherein the image receiving medium extends over the roller or wall, and the print head is upstream of the roller or wall.

47. A printer as claimed in claim 39, further comprising a writer for writing digital information to the tag.

48. A printer as claimed in claim 39, comprising an input device for receiving at least one of said image to printed and digital information.

49. A printer as claimed in claim 48, wherein said input device comprises at least one of a keyboard, touch pad, or touch screen.

50. A printer as claimed in claim 48, wherein said input device comprises a port for receiving at least some of at least one of said digital information and said image data from a data storage device.

51. A printer as claimed in claim 50, wherein said data storage device comprises at lease one of a memory card, a memory stick, or a memory device.

52. A printer as claimed in claim 39, wherein the printer is operable in a first mode in which it is arranged to make a label including the tag, and in a second mode in which it is arranged to make a label excluding the tag.

53. A printer as claimed in claim 39, comprising a database arranged to store information relating to the image printed on said image receiving medium.

54. A printer as claimed in claim 39, wherein read information is stored in a database of said printer.

55. A label printer comprising:
a print head for printing an image on an image receiving medium of an image receiving material, which image receiving material includes the image receiving medium adhered to a backing layer;
wherein the printer is configured:
to peel away the backing layer from the image receiving medium;
to apply a tag to the image receiving medium; and
to reapply the backing layer, or to apply a different liner, to the image receiving medium such that the tag is between the image receiving medium and the backing layer or different liner.

56. A printer as claimed in claim 55, comprising an input device for receiving at least one of said image to printed and digital information.

57. A printer as claimed in claim 56, wherein said input device comprises at least one of a keyboard, touch pad or touch screen.

58. A printer as claimed in claim 56, wherein said input device comprises a port for receiving at least some of at least one of said digital information and said image data from a data storage device.

59. A printer as claimed in claim 58, wherein said data storage device comprises at lease one of a memory card, a memory stick, or a memory device.

60. A printer as claimed in claim 55, wherein the printer is operable in a first mode in which it is arranged to make a label including the tag, and in a second mode in which it is arranged to make a label excluding the tag.

61. A printer as claimed in claim 55, comprising a database arranged to store information relating to the image printed on said image receiving medium.

62. A printer as claimed in claim 55, wherein read information is stored in a database of said printer.

63. A method of creating a label comprising:
printing an image on an image receiving medium;
transferring a tag to the label from a backing layer; and
collecting the backing layer on a take-up spool.

64. A method as claimed in claim 63, wherein the tag is an RFID tag.

65. A method of creating a label comprising:
printing an image on an image receiving medium of an image receiving material, which image receiving material includes the image receiving medium adhered to a backing layer;
peeling away the backing layer from the image receiving medium;
adding a tag to the image receiving medium; and
reapplying the backing layer, or applying a different liner, to the image receiving medium such that the tag is between the image receiving medium and the backing layer or different liner.

66. A method as claimed in claim 65, wherein the tag is an RFID tag.

67. A cassette comprising:
a supply of image receiving material, the image receiving material including an image receiving medium adhered to a backing layer; and
a supply of tags separate from the image receiving material.

68. A cassette as claimed in claim 67, wherein the supply of tags comprises tags arranged in a stack.

69. A supply of tags comprising a carrier and a plurality of tags removably adhered to said carrier.

70. A supply as claimed in claim 69, wherein the tags are RFID tags.

71. A cassette comprising:
a supply of tags as claimed in claim 69; and
a take-up spool;
wherein the carrier extends between the supply of tags and the take-up spool.

72. A cassette as claimed in claim 71, wherein the carrier extends over a roller or wall between the supply of tags and the take-up spool.

73. A cassette as claimed in claim 71, comprising a supply of image receiving tape.

74. A cassette as claimed in claim 73, wherein the image receiving tape extends over the roller or wall.

75. A cassette as claimed in claim 71, comprising a supply of ink ribbon.

76. A supply for a label printer comprising:
image receiving medium for receiving an image;
tags for receiving digital information; and
a backing layer;
wherein the tags are adhered to the image receiving medium between the image receiving medium and the backing layer, and a filler material is provided around the tags between the image receiving medium and the backing layer.

77. A supply as claimed in claim 76, further comprising an adhesive layer on the backing layer, to which adhesive layer a removable peel layer is adhered.

78. A supply as claimed in claim 77, wherein the adhesive layer is such that, when the peel layer is removed, the backing layer is capable of being adhered to a surface.

79. A supply as claimed in claim 76, further comprising a lamination layer applied to the image receiving medium on the opposite side of the image receiving medium from the tags.

80. A supply as claimed in claim 76, wherein said image receiving medium comprises a plurality of discrete labels.

81. A supply as claimed in claim 76, wherein said image receiving medium comprises a continuous supply of image receiving medium.

82. A supply as claimed in claim 76, wherein said tags are selected from the group consisting of RF tags, RFID tags, optical tags, integrated circuits, and cards.

83. A cassette comprising a supply as claimed in claim 76.
